(19) United States
(12) Patent Application Publication
(10) Pub. No.: US 2025/0101221 A1
(43) Pub. Date: Mar. 27, 2025

(54) BIODEGRADABLE POLYMER BASED BIOCOMPOSITES

(71) Applicant: CTK Research and Development Canada LTD., Surrey, British Columbia (CA)

(72) Inventors: Tizazu H. MEKONNEN, Waterloo, Ontario (CA); Arvind GUPTA, Waterloo, Ontario (CA)

(73) Assignee: CTK Research and Development Canada LTD., Surrey, British Columbia (CA)

(21) Appl. No.: 18/577,293

(22) PCT Filed: Jul. 7, 2022
(86) PCT No.: PCT/CA2022/051065

§ 371 Date: Jan. 8, 2024

Related U.S. Application Data
(60) Provisional application No. 63/219,344, filed on Jul. 7, 2021.

(51) Int. Cl. C08L 67/06; B29C 48/375; B29K 1/00; B29K 67/00; B29K 96/02; B29K 105/00; C08K 3/013; C08K 5/00

(52) U.S. Cl. CPC C08L 67/06; B29C 48/375; C08K 3/013; C08K 5/0016; B29K 2001/00; B29K 2067/06; B29K 2096/02; B29K 2105/0038; B29K 2105/0088; B29K 2105/251; C08L 2201/06; C08L 2205/03; C08L 2205/08

(57) ABSTRACT

The present invention provides compositions for use in making biodegradable biodegradable composite, and biodegradable composite comprising polybutylene adipate terephthalate (PBAT)-component; hemp powder; and optionally one or more compatibilizers and/or PBAT grafted with one or more compatibilizers selected from maleic anhydride, glycidyl methacrylate, pyromellitic anhydride, acrylic acid, polyacrylic acid, methylene diphenyl diisocyanate, poly(glycidyl methacrylate, copolymer(s) of glycidyl methacrylate and/or copolymers of acrylic acid. The invention also relates to methods of preparing the composites.

### FIELD OF THE INVENTION

The present invention pertains to the field of biodegradable polymeric material. In particular, it relates to polymer-bases biocomposites, and method of making same.

### BACKGROUND OF THE INVENTION

Plastics have contributed a significant role in the development of human society in the last century [1]. Majority of plastic materials are mainly derived from fossil fuels [2]. These petroleum-derived plastics are strong, tough, rigid, durable, relatively lightweight, inexpensive, long-lasting and thermally and chemically stable depending on the type of polymer used in its respective application [3], making them the material to go for single-use applications, such as packaging, construction, transportation, consumer goods, etc. However, unmanaged and uncontrolled release of after-use plastics became a huge environmental pollution burden [4].

Recent efforts towards sustainable approach to the management of plastics have led to heightened interest to utilize biodegradable and/or biobased polymers which includes polylactic acid (PLA), polyhydroxyalkanoates (PHA), polybutylene adipate terephthalate (PBAT), polybutylene succinate (PBS), polycaprolactone (PCL) etc., to produce single-use consumer goods [5].

Among biodegradable polymers, polybutylene adipate terephthalate (PBAT), an aliphatic-aromatic copolyester, is one of the most attractive biodegradable polymers that is touted to replace single-use plastics in consumer goods and packaging applications. In addition to its biodegradability, PBAT has competitive mechanical properties to a range of commodity plastic, making it appealing for food packaging and consumer goods applications. However, it is about three times more expensive than low-density polyethylene, and suffers from low stiffness/rigidity and relatively low service temperature, that has prohibited its wide-spread application in the cost-competitive commodity plastics space [6].

The use of bio-resourced materials as fillers in the development of biocomposites is an effective approach to improve the modulus and reduce the cost of the end products [7]. Different bio-sourced materials, such as lignin [8], chitin [9], silk powder [10], natural fibers [11, 12], coffee ground [13], lingo-cellulosic fillers [14], microalgae biomass [15], distillers dried grains with solubles [16], corn residues [17], other biomass [18, 19] etc. have been explored by numerous researchers for PBAT based biocomposites. The poor interfacial adhesion between the typically hydrophobic polymer matrices, such as PBAT and hydrophilic bio-resourced fiber based fillers, is one of the outstanding challenges of biocomposites.

Therefore there is a need for cost-competitive, biodegradable materials having desired mechanical and/or thermomechanical properties that can be prepared from biodegradable polymers and sustainable, low cost, and biodegradable fillers, for replacing conventional plastics.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide biodegradable biocomposites based on PBAT.

In accordance with an aspect of the present invention, there is provided a composition for making a biodegradable composite, the composition comprises a composition for use in making a biodegradable biocomposite, the composition comprising: a) about 30 to 99.5% by weight of a polybutylene adipate terephthalate (PBAT)-component; b) about 0.5 to 50% by weight hemp residue; and c) optionally about 0.1 to 50% by weight of: PBAT grafted with one or more compatibilizers selected from maleic anhydride, glycidyl methacrylate, pyromellitic anhydride, acrylic acid, polyacrylic acid, methylene diphenyl diisocyanate, poly(glycidyl methacrylate, copolymer(s) of glycidyl methacrylate and/or copolymers of acrylic acid, and/or one or more compatibilizers selected from maleic anhydride, pyromellitic anhydride, acrylic acid; polyacrylic acid, and methylene diphenyl diisocyanate.

In accordance with an aspect of the present invention, there is provided a biocomposite comprising or made from: a) about 30-99.5% by weight polybutylene adipate terephthalate (PBAT)-component; b) about 0.5 to 50% by weight hemp residue; and optionally about 0.1 to 50% by weight of: PBAT grafted with one or more compatibilizers selected from maleic anhydride, glycidyl methacrylate, pyromellitic anhydride, acrylic acid, polyacrylic acid, methylene diphenyl diisocyanate; poly(glycidyl methacrylate, copolymer(s) of glycidyl methacrylate and/or copolymers of acrylic acid, and/or one or more compatibilizers selected from maleic anhydride, pyromellitic anhydride, acrylic acid; polyacrylic acid, and methylene diphenyl diisocyanate, wherein the mixture has been heated.

In accordance with another aspect of the invention, there is provided a method of preparing a biodegradable biocomposite as described herein, the method comprises: a) admixing the PBAT-component with hemp residue, and optionally with the compatibilizer, and b) extruding said admixture at an extrusion temperature sufficient to melt at least the PBAT.

In accordance with another aspect of the invention, there is provided a method of preparing a biodegradable biocomposite as described herein, the method comprises: a) preparing a grafted PBAT, by combining PBAT with one or more compatibilizers, and a free radical initiator to form a reaction mixture, and melt processing the reaction mixture to form the grafted PBAT; and b) mixing the grafted PBAT prepared in step a) with PBAT-component, hemp residue, and optional plasticizer(s) and/or filler(s), and extruding said mixture at an extrusion temperature sufficient to melt at least the PBAT.

### BRIEF DESCRIPTION OF THE FIGURES

The invention will now be described by way of an exemplary embodiment with reference to the accompanying figures, wherein:

FIG. 1A is morphological analysis of hemp residue, FIG. 1B is a FTIR spectra for hemp residue,

FIG. 1C is thermogravimetric data of hemp residue, and FIG. 1D is derivative weight loss data of the hemp residue.

FIG. 2 is FTIR spectra of PBAT before (lower) and after (upper) MA grafting.

FIGS. 3A-3B depict DSC thermograms of the PBAT and its biocomposites at different hemp residue content levels and the presence of MA. FIG. 3A depicts heating curves and FIG. 3B depicts Cooling curves.

FIGS. 4A-4D depict the results of TGA study of the biocompsites in accordance with embodiments of the present invention. FIG. 4A depicts percent weight loss of prepared specimens, without mPBAT against temperature, and FIG. 4B depicts percent weight loss of prepared specimens with mPBAT against temperature.

FIGS. 5A-5D depict the results of tensile testing of the exemplary biocompsites in accordance with embodiments of the present invention. FIG. 5A depicts mechanical strength and elongation at break; FIG. 5B depicts tensile modulus and toughness; and FIG. 5C depicts corresponding stress-strain curve of developed biocomposites, and FIG. 5D depicts effect of HP on heat deflection temperature of biocomposites.

FIGS. 6A-6D depict effect of temperature on specimen load bearing capability, wherein FIGS. 6A and 6B depict storage modulus of the biocomposite in accordance with an embodiment of the present invention without and with mPBAT, and FIGS. 6C and 6D depict tan delta of the biocomposite without and with mPBAT.

FIGS. 7A-7C depict rheological properties of PBAT and its biocomposites with and without the presence of MA in accordance with embodiments of the present invention. FIG. 7A depicts complex viscosity, FIG. 7B depicts storage modulus, and FIG. 7C depicts loss modulus.

FIG. 8A is SEM micrographs of hemp powder, FIG. 8B depicts fractured surfaces of neat PBAT, FIG. 8C depicts fractured surface of PBAT-10HP biocomposite in accordance with an embodiment of the present invention, and FIG. 8D depicts fractured surface of PBAT-40HP biocomposite in accordance with an embodiment of the present invention.

FIGS. 9A-9D depict SEM micrographs of different magnifications of fractured surfaces of PBAT-40HP at (a) 500× and (b) 1000×; and fractured surfaces of PBAT-40HP-M at (c) 500× and (d) 1000×.

FIG. 10 depicts gel content in developed biocomposite due to the presence of mPBAT.

FIG. 11 depicts Representative cutlery and flexible sheets prepared by compression molding using PBAT-40HP-M biocomposite in accordance with an embodiment of the invention.

### DETAILED DESCRIPTION OF THE INVENTION

Unless defined otherwise, all technical and scientific terms used herein have the same meaning as commonly understood by one of ordinary skill in the art to which this invention belongs.

As used herein, the term “about” refers to a +/−10% variation from the nominal value. It is to be understood that such a variation is always included in a given value provided herein, whether or not it is specifically referred to.

As used herein, the term “hemp residue” (HR), refers to ground hemp stalk wherein the hemp hurd and/or fibers are ground and/or sliced into micron size particles. The residue can be in the form of powder or dust.

As used herein, the term “biodegradable” refers to a material that degrades or breaks down upon exposure to sunlight or ultra-violet radiation, water or dampness, microorganisms such as bacteria and fungi, enzymes or wind abrasion. In some instances, rodent, pest, or insect attack can also be considered as forms of biodegradation or environmental degradation.

As used herein, the term “thermoplastic starch” (TP starch) refers to starch blended with suitable plasticizer(s).

The present invention relates to novel compositions for making a biodegradable biocomposite, and the biodegradable biocomposites formed from these compositions.

The biocomposites of the present invention exhibit enhanced tensile modulus, tensile strength, and heat deflection while maintaining sufficient toughness of biocomposites, and exhibit overall appealing material properties, and compostability compared to the neat PBAT, making it attractive for a range of single-use consumer goods, such as fast-food utensils, cosmetic containers, and food containers.

In one aspect, the present invention provides a composition for use in making a biodegradable biocomposite, which comprises: a) about 30-99.5% by weight of a polybutylene adipate terephthalate (PBAT)-component; and about 0.5 to 50% by weight hemp residue. The composition also optionally comprises about 0.1 to 50% by weight one or more compatibilizers selected from maleic anhydride, glycidyl methacrylate, pyromellitic anhydride, acrylic acid;

polyacrylic acid; methylene diphenyl diisocyanate; poly(glycidyl methacrylate, copolymer(s) of glycidyl methacrylate and copolymers of acrylic acid, and/or about 0.1 to 50% by weight of PBAT grafted with one or more compatibilizers selected from maleic anhydride, glycidyl methacrylate, pyromellitic anhydride, acrylic acid, polyacrylic acid, methylene diphenyl diisocyanate, poly(glycidyl methacrylate, copolymer(s) of glycidyl methacrylate and/or copolymers of acrylic acid.

In another aspect, the present invention provides a biodegradable biocomposite, which is made from a mixture of about 30-99.5% by weight polybutylene adipate terephthalate (PBAT)-component; and about 0.5 to 50% by weight hemp residue. The mixture optionally comprises about 0.1 to 50% by weight one or more compatibilizers selected from one or more maleic anhydride, glycidyl methacrylate, pyromellitic anhydride, acrylic acid; polyacrylic acid, methylene diphenyl diisocyanate, poly(glycidyl methacrylate, copolymer(s) of glycidyl methacrylate and copolymers of acrylic acid, and/or about 0.1 to 50% by weight of PBAT grafted with one or more compatibilizers selected from maleic anhydride, glycidyl methacrylate, pyromellitic anhydride, acrylic acid, polyacrylic acid, methylene diphenyl diisocyanate; poly(glycidyl methacrylate, copolymer(s) of glycidyl methacrylate and/or copolymers of acrylic acid, wherein the mixture is heated.

The PBAT-component of the present invention can be polybutylene adipate terephthalate (PBAT) polymer, a mixture of PBAT, starch and a plasticizer, or a blend of PBAT and thermoplastic starch.

In some embodiments, the PBAT component is polybutylene adipate terephthalate (PBAT).

In some embodiments, the PBAT-component is a mixture of PBAT, starch, and a plasticizer, wherein PBAT is about 50-65% by weight of the composition, the starch is about 15 to 35% by weight of the composition, and the plasticizer is about 10 to 15% by weight of the composition.

In some embodiments, the PBAT-component is a PBAT-thermoplastic starch blend, wherein PBAT is about 50-65% by weight of the composition, and the thermoplastic starch is about 30 to 40% by weight of the composition.

In some embodiments, the composition and/or biocomposite of the present invention comprises one or more compatibilizers selected from maleic anhydride, pyromellitic anhydride, acrylic acid; polyacrylic acid, methylene diphenyl diisocyanate, and copolymers of acrylic acid.

In some embodiments, the composition and/or biocomposite of the present invention comprises one or more compatibilizers selected from maleic anhydride, glycidyl methacrylate, pyromellitic anhydride and methylene diphenyl diisocyanate.

In some embodiments, the composition or biocomposite of the present invention comprises PBAT grafted with one or more of maleic anhydride, glycidyl methacrylate, pyromellitic anhydride and acrylic acid.

In some embodiments, the composition and/or the biocomposite of the present invention further comprises about 20-40% of a plasticizer.

Non-limiting examples of suitable plasticizers include polyols (such as glycerol), ethylene glycol, polyglycerol, sorbitol, sucrose, fructose, glucose, urea, acetylated monoglycerides alkyl citrates, triethyl citrate (TEC), acetyl triethyl citrate (ATEC), tributyl citrate (TBC), acetyl tributyl citrate (ATBC), trioctyl citrate (TOC), acetyl trioctyl citrate (ATOC), trihexyl citrate (THC), acetyl trihexyl citrate (ATHC), butyryl trihexyl citrate (BTHC), trimethyl citrate (TMC), alkyl sulfonic acid phenyl ester (ASE), lignosulfonates, beeswax, oils, sugars, polyols such as sorbitol and glycerol, low molecular weight polysaccharides, diethylene glycol dibenzoate (DEGDB), 1,5-propanediol dibenzoate (1,5-PDB), propylene glycol dibenzoate (PGDB), dipropylene glycol dibenzoate (DPGDB), alkyl dibenzoates, succinates, maleates, fumarate, or a combination thereof.

In some embodiments, the plasticizer is selected from diethylene glycol dibenzoate (DEGDB), 1,5-propanediol dibenzoate (1,5-PDB), propylene glycol dibenzoate (PGDB), dipropylene glycol dibenzoate (DPGDB), alkyl dibenzoates, succinates, maleates, fumarate, or a combination thereof.

The hemp residue of the present invention can be prepared by milling and/or grinding the hemp stalk to obtain micron size particles. In some embodiments, hemp residue comprises ground hemp hurd and bast fibers. In some embodiments, the hemp residue is primarily composed of the hemp core and residual bast fibers. In some embodiments, the hemp residue is composed of hemp hurd. In some embodiments, the residue is in the form of a powder.

In some embodiments, before milling or grinding, the hemp stalk is washed with about 2-10% solution of sodium hydroxide in water (1 part stalk per 10 parts solution by weight), and then dried.

In some embodiments, the hemp residue comprises particles having length about 75 to 150 μm, width about 15 to 40 μm, and an aspect ratio of about 3.5 to 5. In some embodiments, the hemp powder has density about 1.0 to 2.0 g/cm³.

In some embodiments, the hemp residue comprises about 60-75% cellulose, 5-15% hemicellulose and about 10-25% lignin.

In some embodiments, the hemp residue is pre-treated to remove tetrahydrocannabinol (THC) & cannabidiol (CBD).

In some embodiments, the composition and/or the biocomposite of the present invention comprises PBAT as the PBAT-component, hemp residue and a compatibilizer or PBAT grafted with one or more compatibilizers.

In some embodiments, the composition and/or the composite of the present invention comprises 30 to 99% of PBAT, about 5 to about 40% hemp residue, and about 0.1 to 20% PBAT grafted with one or more compatibilizers. In some embodiments, the compatibilizer is maleic anhydride.

In some embodiments, the composition comprises:
about 50 to 70% by weight PBAT;
about 25 to 30% by weight starch;
about 10 to 15% by weight glycerol;
about 0.2 to 0.7% by weight stearic acid; and
about 0.2% to about 0.7 by weight hemp residue.

The starch can be any plant starch (root and/grain starch), such as potato starch, sweet potato starch, corn starch, bracken starch, wheat starch, cassava starch, sago palm starch, rice starch, tapioca starch, soybean starch, arrow root starch, lotus starch, buckwheat starch or any mixture thereof.

In some embodiments, starch is unprocessed (i.e. in a natural state thereof), wherein the starch has not been modified by chemical or any other means.

In some embodiments, composition and/or the biocomposite comprises about 1 to 3% by weight of a processing agent, such as glycerol monostearate and/or stearic acid.

In some embodiments, composition and/or the biocomposite comprise an inorganic filler (such as, talc, clay, wollastonite, montmorillonite, or carbonate, bicarbonate, oxide or sulfate of alkali metal or alkali earth metal).

In some embodiments, the composition further comprises about 0.5-5% a colorant, such as mineral and/or dye. In some embodiments, the composition comprises about 1% colorant.

In another aspect, the present invention provides a method of preparing a biodegradable biocomposite of the present invention. The method comprises, admixing the PBAT-component with hemp residue, and optionally with a compatibilizer or compatibilizer-grafted PBAT described herein, and extruding the admixture at an extrusion temperature sufficient to melt at least the PBAT. In some embodiments, the admixture is extruded via a screw extruder at a screw speed of about 80-120 rpm, at a processing temperature of about 150°-220° C. In some embodiments, the admixture is extruded via a screw extruder with a screw speed of about 380-450 rpm, at a processing temperature of about 130°-200° C.

In some embodiments, the PBAT-component and hemp powder are dried to remove residual moisture before processing. The drying step can be achieved in a conventional oven at about 60-100° C., or via common industrial methods of drying, for example, using a desiccant wheel dryer or a Munters desiccant wheel (at about 40-60° C. overnight).

In some embodiments, the resulting biocomposite is air-cooled and pelletized.

In some embodiments, the compatibilizer-grafted PBAT can be prepared by combining PBAT with the one or more compatibilizers and a free radical initiator to form a reaction mixture, and melt processing the reaction mixture to form the grafted PBAT.

In some embodiments, PBAT is first mixed with one or more compatibilizers and heated to a temperature sufficient to melt at least one of the compatibilizer, followed by adding the free radical initiator prior to the melt processing.

In some embodiments, the melt processing is achieved at a temperature of about 150°-220° C.

In some embodiments, the melt processing comprises melt extrusion. In some embodiments, the melt extrusion is performed via a screw extruder at a screw speed of about 80-120 rpm, at a feed rate of about 300-750 g/h.

In some embodiments, the produced biocomposite is dried to remove unreacted compatibilizer.

In some embodiments, the biocomposite of the present invention, which comprises PBAT grafted with one or more compatibilizers, can be prepared by:
a) first preparing the grafted PBAT by combining PBAT with one or more compatibilizers and a free radical initiator to form a reaction mixture, and melt processing the reaction mixture to form the grafted PBAT; and
b) then mixing the grafted PBAT prepared in step a) with PBAT-component, hemp residue, and optional plasticizer(s) and/or filler(s), and extruding said mixture at a processing temperature sufficient to melt at least the PBAT.

In one aspect, the present invention provides a biocomposite made by the methods described herein.

To gain a better understanding of the invention described herein, the following examples are set forth with reference to the accompanying figures. It will be understood that these examples are intended to describe illustrative embodiments of the invention and are not intended to limit the scope of the invention in any way.

### EXAMPLES

### Example 1: Preparation of Hemp Powder (HP)

To produce the HP, the bast fiber was removed from the stalk and the remaining woody core (also called hurd) and residual fiber was processed with a milling machine to prepare a fine powder of hemp hurd and residual fiber with micron-sized particles. The resulting HP contained less than 1% tetrahydrocannabinol (THC).

### Lignin and Cellulose Content Measurement of HP

The lignin content of the hemp powder (HP) was determined using a procedure adopted by Zhu et al. [20]. Briefly, 1 g of the dried HP was treated with ethanol for 4 h at 30° C. to remove pectin and wax, which was found to be around 2-5%. The ethanol washed hemp powder was then subjected to 72% aqueous sulphuric acid solution digestion at 20° C. for 2 h with continuous stirring. After the acid digestion, the solution was diluted to 3% total acid content with enough distilled water and boiled for 4 h. The digested mass was subsequently cooled down to room temperature and filtered followed by washing with distilled water. The insoluble content, which was the lignin (L in gram), was dried in a conventional oven at 80° C. for 24 h and weighed. The remaining soluble content was considered as the cellulosic content (cellulose and hemicellulose) of the HP.

The α-cellulose was quantified by separating the cellulose from HP via dissolving lignin and hemicellulose in an aqueous solution of NaOH (2.5 mol L⁻¹) and Na₂SO₃ (0.4 mol L⁻¹). A predetermined amount of HP was suspended in a basic solution and refluxed for 12 h at 100° C. After dissolving lignin and hemicellulose, the undissolved content was recovered and washed several times with distilled water to get rid of residual chemicals. The recovered solid was bleached to remove the colorants with boiling hydrogen peroxide solution (2.5 mol L⁻¹). The white solid content was recovered and washed thoroughly with cold distilled water, dried at 80° C. overnight and weighed.

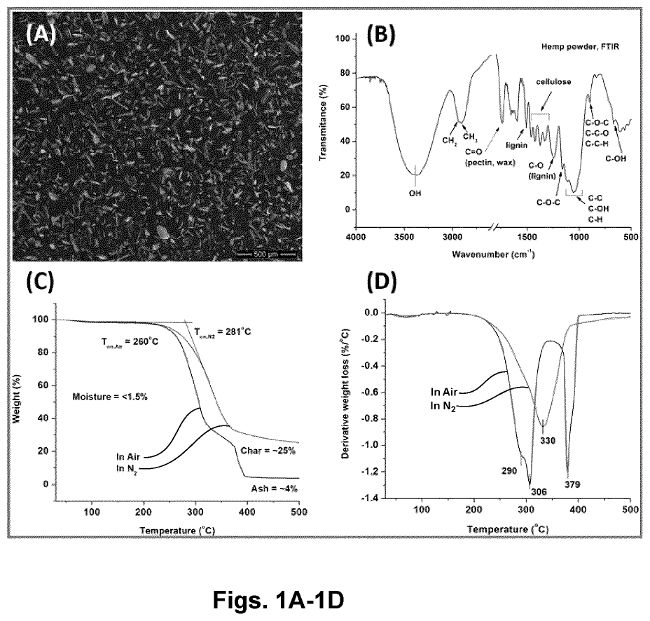

The particle size of the hemp powder prepared as described above was found to be around 120 μm in length and 27 μm in width with an aspect ratio of about 4.4, using microscopic imaging shown in FIG. 1A. The density of HP was measured to be 1.27 gm/cm³ using back-calculation after the reactive extrusion process.

Constituents such as cellulose, hemicellulose and lignin in hemp powder (HP) were measured using the digestion and acid hydrolysis technique and are listed in Table 1.

TABLE 1
Physico-chemical characteristics of hemp powder

| TGA data | | | | | | | | | | | |
|---|---|---|---|---|---|---|---|---|---|---|---|
| | Ash | Char | Moisture | | | | Hemi- | | Particle size | | |
| | content | content | content | Tₘₐₓ | Tₒₙ | Lignin | cellulose | Cellulose | Length | Width | Density |
| Environment | (%) | (%) | (%) | (º C.) | (º C.) | (%) | (%) | (%) | (μm) | (μm) | gm/cm³ |
| Nitrogen | — | ~25 | <1.5 | 330 | 281 | 18-20 | 11-12 | 68-70 | 119 ± 35 | 27 ± 11 | 1.27 ± 0.04 |
| Air | ~4 | — | | 290 | 260 | | | | | | |

The presence of 68-70% of cellulose confirms the abundance of hydroxyl functional group on the surface of HP. The presence of functional groups on HP was confirmed using FTIR and a typical spectrum is shown in FIG. 1B. The peaks corresponding to carboxylic functional groups (C═O) and C—O of pectin and wax were present in the HP and observed at around 1744 cm⁻¹ and 1249 cm⁻¹, respectively. The stretching vibration of hydroxyl groups, symmetric and asymmetric stretching vibration of C—H group of cellulose noted as a broad peak at 3380 cm⁻¹, 2903 cm⁻¹, and 2937 cm⁻¹, respectively. Peaks between 1312 cm⁻¹ to 1465 cm⁻¹ correspond to cellulose and hemicellulose. Contrarily, spectra ranging from 881 cm⁻¹ to 1168 cm⁻¹ correspond to the backbone structure of cellulose and hemicellulose. Overall, these spectra confirm the presence of pectin, wax, lignin, cellulose, and hemicellulose in the HP used in this study.

### Example 2: Preparation of MA-grafted PBAT

An industry-viable melt extrusion technique was employed to produce MA-grafted PBAT (mPBAT). Initially, PBAT pellets were mixed with 5 wt. % maleic anhydride (MA) and kept in a hot air oven at 80° C. for about 30 min to melt the MA and create thin crust coating over PBAT pellets. The mixture was cooled mixed with 1 wt. % dicumyl peroxide (DCP) as a reaction initiator stirred before melt processing. The reactive extrusion was conducted in a twin-screw extruder (Thermo Scientific, Haake Process 11, USA) equipped with 8 temperature zones with a temperature profile of 130/135/140/150/150/140/135/130° C. from the die to feed. The screw (440 mm length, 40:1 L/D) speed was kept at 60 rpm (to ensure sufficient reaction time) at a feed rate of around 500 g/h. The produced mPBAT was then pelletized, weighed, and dried in a vacuum oven under reduced pressure (100 mbar), and temperature of 80° C. for 24 h to remove unreacted MA from the sample.

### Quantification of Grafted MA on PBAT

The grafted MA on PBAT was quantified by a titration technique as follows: 1 g of mPBAT was dissolved in 50 mL of chloroform followed by the addition of few drops of hydrochloric acid (HCl) to hydrolyze of all anhydride groups present on the mPBAT.

The hydrolysis of the anhydride groups leads to the formation of carboxylic acid functionality that was detected as acid value as per ASTM D1386 standard. The hydrolyzed solution was titrated with 0.1 M potassium hydroxide (KOH) dissolved in alcohol in the presence of phenolphthalein as an indicator. The percentage of MA was measured using equation (1).

$$\% MA Grafted = \frac{MV ( 56.1 ) ( 100 )}{2 W} \qquad ( 1 )$$

Where, M, V, and W are molarity, endpoint volume (in liters) of KOH solution used and weight of sample used (in chloroform), respectively. The MA Grafting (calculated based on an average of 5 endpoint volumes) in mPBAT are presented in percent.

### Example 3: Fabrication of Biocomposites Comprising PBAT, Hemp Residue and Optionally PBAT Grafted with Compatibilizer

The PBAT and hemp powder (HP) were weighed and dried overnight in a conventional oven at 80° C. to remove residual moisture before processing. The PBAT was then mixed with different content of HP and mPBAT as shown in Table 2 and melt processed via a twin-screw extruder with a screw speed of 100 rpm at a processing temperature of 180° C. (all zone). The produced biocomposites were air-cooled and pelletized. The obtained pellets were used to prepare specimens for tensile test, dynamic mechanical analysis (DMA), and rheology measurements using a piston injection molding system ((HAAKE™ MiniJet Pro, Thermo Fisher Scientific, USA) at cylinder temperature, mold temperature and pressure of 190° C., 30° C., and 700 bar, respectively. Specimens prepared as such were stored in a zip lock bag for further use. Any further addition of HP beyond 40 wt. % over torqued the extruder because of the increased viscosity, and hence it was not pursued in this research.

TABLE 2
Constituent of the developed biocomposite batches

| Batch # | PBAT (%) | HP (%) | mPBAT (%) | Sample code |
|---|---|---|---|---|
| | 100 | 0 | 0 | PBAT |
| | 90 | 10 | 0 | PBAT-10HP |
| | 80 | 20 | 0 | PBAT-20HP |
| | 70 | 30 | 0 | PBAT-30HP |
| | 60 | 40 | 0 | PBAT-40HP |
| | 80 | 10 | 10 | PBAT-10HP-M |
| | 70 | 20 | 10 | PBAT-20HP-M |
| | 60 | 30 | 10 | PBAT-30HP-M |
| | 50 | 40 | 10 | PBAT-40HP-M |

### Quantification of Gel Content

The formation of a gel in the developed biocomposites can be a qualitative indicator of the reaction between the anhydrides of the mPBAT and the —OH moieties of the HP. Thus, the gel content was quantified via Soxhlet extraction through the continuous washing of about 0.5 g of each sample in chloroform at 80° C. The samples were then wrapped in a filter paper and placed in the extraction chamber. Chloroform was used as the extraction solvent in the Soxhlet setup. The extraction chamber was manually emptied and the process was repeated for a total of 16-20 cycles. This ensured that any PBAT and unreacted mPBAT be fully removed from the sample whilst restricting gel and HP from escape. Filter papers were weighed before and after the extraction and gel content values were calculated as percent values of the initial weight. The Soxhlet extraction did not remove the existing unreacted hemp powder from the samples (as there was no coloration of the solvent). The percentage gel content was calculated using the following equation (2)

$$Gel content = \frac{{W}_{i} - ( {W}_{f} - C )}{{W}_{i}} \times 100 \qquad ( 2 )$$

Where Wᵢ, W_{f} and C are initial sample weight, sample weight after Soxhlet extraction and HP content of the sample.

### Characterization

### Fourier Transform Infrared Spectroscopy

Fourier transform infrared spectroscopy (FTIR) scans were collected using a Nicollet 6700 from Thermo Scientific. 50 mg of each sample was dissolved into 10 ml of chloroform. Once dissolved, a small amount (less than 1 mL) of the solution was dripped onto neat KBr salt pellets. FTIR analysis was then conducted with 64 scans in a nitrogen (N₂) background.

### Mechanical and Thermo-Mechanical Analysis

Tensile properties of the samples were measured using a Universal Tensile Machine AGS-X series from Shimadzu, Japan by employing a 500 N load cell at crosshead speed of 5 mm/min with a gauge length of 25 mm. At least five specimens were tested for tensile properties and their average measurements and standard deviations were reported. Specimens were injection molded in dumbbell shape as per ASTM D638 type V with average dimensions of 50 mm (gauge length)×3.3 mm (thickness)×3.2 mm (width).

Thermo-mechanical data were recorded using a DMA machine (Q800, TA Instruments, USA). For this, samples were tested in strain mode using dual-cantilever orientation at 1 Hz frequency within the temperature range −80° C. to 90° C. at a heating rate of 3° C./min. Rectangular samples (50 mm (length, L)×11.9 mm (width, W)×3 mm (thickness, T)) were injection molded as per ASTM D648-07 for the DMA test. The heat deflection temperature (HDT) of the specimens were also evaluated using DMA. The force (F), strain (8) and deflection (D) required for the measurement was calculated as per the equation given elsewhere as follows.

$$F = \frac{2}{3} [ \frac{σ ( {T}^{2} \times W )}{L} ] \qquad ( 3 )$$

$$ε = 6 \times \frac{{D}_{ASTM} \times {T}_{ASTM}}{{L}_{ASTM}^{2}} \qquad ( 4 )$$

$$D = ε \times \frac{{L}_{sample}^{2}}{6 \times {T}_{sample}} \qquad ( 5 )$$

Where, σ taken as 0.455 MPa stress on the specimen.

### Scanning Electron Microscopy (SEM)

The fractured surface morphologies of the developed biocomposites were examined using a Zeiss Leo 1530 field emission scanning electron microscope (FE-SEM). The prepared fractured samples were lightly coated with gold nanoparticles to obtain high-resolution images.

### Differential Scanning Calorimeter (DSC)

The thermal behavior of PBAT and its biocomposites were investigated using a differential scanning calorimeter (DSC) (Q2000 from TA Instruments, USA), with a typical heat-cool-heat program. Approximately 5 mg of each sample were first cooled to −80° C., then the samples were heated from −80° C. to 160° C. with a heating rate of 10° C./min. The samples were then cooled back to −80° C., and lastly heated again to 160° C. at the same heating rate. The glass transition temperature (T_{g}), melting temperature (Tₘ), and enthalpy of fusion (ΔHₘ) of the cooling and second heating curves of the DSC thermogram was used to investigate the change of thermal behavior of the PBAT after the incorporation of different HP loading levels. The degree of crystallinity (X_{c}) of the PBAT and its biocomposites was calculated from the ratio of area under the second melting peak of the DSC thermogram to the enthalpy of melting for 100% crystalline PBAT as shown in Equation (6) below

$${X}_{C} = \frac{Δ {H}_{m}}{Δ {H}_{m 100} ( 1 - {w}_{f} )} \times 100 \% \qquad ( 6 )$$

Where ΔHₘ is the enthalpy of melting for the PBAT samples, ΔHₘ100 is the enthalpy of melting for 100% crystalline PBAT (i.e. 114 J/g [22]) and w_{f} is the weight fraction of the hemp powder loadings.

### Thermogravimetric Analysis (TGA)

All extruded samples were pelletized into about 2 mm pieces before characterizing it with a TGA (2 Star System, Mettler Toledo, Switzerland). The TGA scan was conducted from 30° C. to 700° C. at a heating rate of 10° C./minute in nitrogen (N₂) environment. The collected data was analyzed for the temperature peak and onset values.

### Rheology

The melt rheology properties of the neat PBAT and its biocomposites with and without mPBAT were investigated using a Rheometer (Thermo Scientific, HAAKE MARS III, USA). The samples were heated to 180° C. within the linear viscoelastic (LVE) region with a parallel plate setup. A 35 mm diameter plate with a 1 mm gap between the plates was employed for the study. A strain of 1% was applied and the rheological properties of the PBAT biocomposites within the frequency range of 0.01 to 100 Hz were reported.

### MA Grafting of PBAT

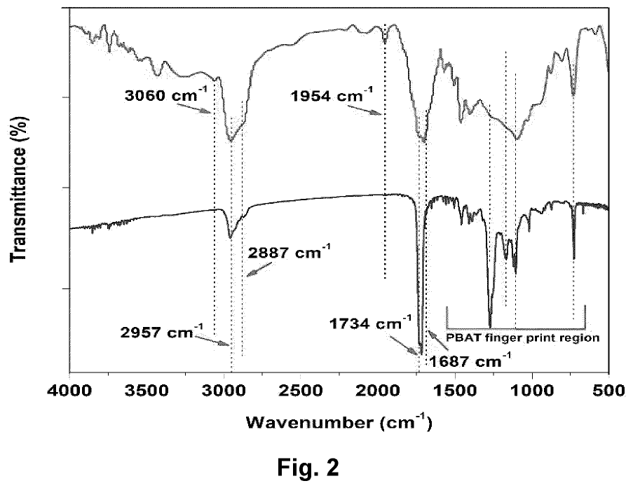

The grafting of MA onto PBAT was confirmed using FTIR analysis as shown in FIG. 2. In the case of PBAT, peaks at 2957 cm⁻¹, 2887 cm⁻¹ and 1734 cm⁻¹ correspond to the stretching vibration of symmetric and asymmetric C—H group and —C═O group, respectively. Other peaks around 1100 cm⁻¹ to 1600 cm⁻¹ in the fingerprint region were attributed to stretching vibration of PBAT backbone C—O—C and phenylene groups of PBAT chains. The appearance of a new peak at 3060 cm⁻¹ and 1954 cm⁻¹ correspond to ═C—H stretching vibration in anhydride and asymmetric stretching of C═C group developed between anhydride and PBAT chains, respectively. A new shoulder developed at 1687 cm⁻¹ is assigned to carbonyl functional groups of lower molecular weight PBAT generated due to β-scission of chains. Altogether, radical initiated MA grafting is successfully carried out. Furthermore, the extent of malation based on the titration study was found to be 2.27%+0.28 using equation (1) [23].

### Thermal Behaviors of PBAT/Hemp Powder Biocomposites

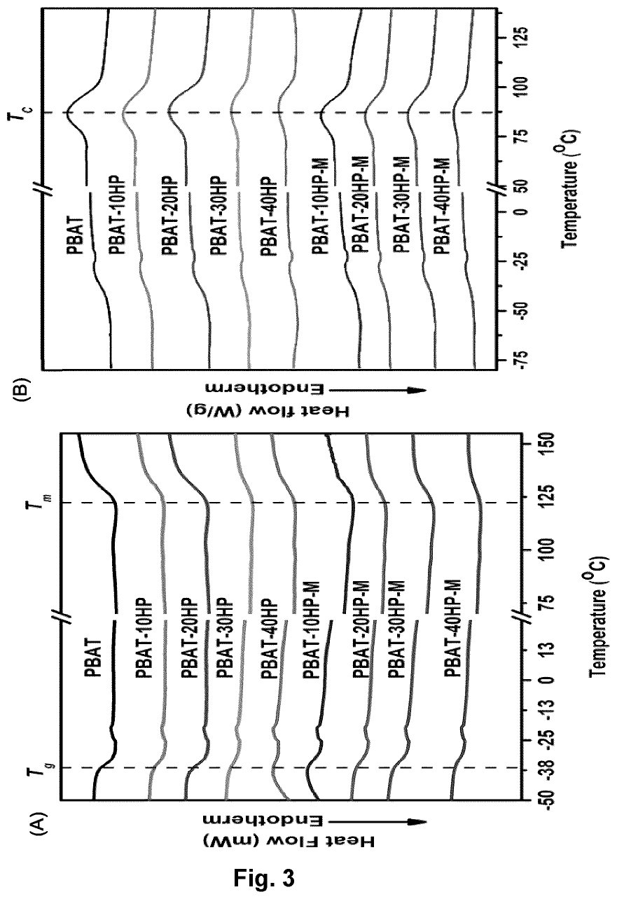

The DSC heating and cooling thermogram of PBAT/HP at different hemp powder content are shown in FIG. 3 (A & B). The data extracted from the DSC thermogram, i.e. glass transition temperature (T_{g}), melting temperature (Tₘ), crystallization temperature (T_{c}), and degree of crystallinity (X_{c}) are presented in Table 3. There was no significant shift of the T_{g} of the PBAT (less than 1° C.) after the incorporation of hemp powder from 10 to 40 wt %. However, the T_{g} of the PBAT with mPBAT was shifted to a higher temperature in the mPBAT/HP biocomposites. This indicated the enhanced interactions between PBAT and HP as a result of the coupling effects of MA grafting. The PBAT polymer chain motion was restricted from the strong interphase adhesions with HP due to presence of mPBAT and hence increases the T_{g}.

Tₘ of the PBAT has shifted to a higher temperature after the incorporation of hemp powder (approximately 1-3° C. increased), wherein the 10 wt % hemp-filled PBAT biocomposite showed the highest increment on the Tₘ. A similar trend was observed for the PBAT-HP/mPBAT biocomposites, where at 10 wt % of the hemp powder showed the highest increment in the Tₘ-In comparison to the hemp/PBAT with and without the presence of mPBAT in all range of hemp powder loadings, the Tₘ of the PBAT-HP biocomposites has reduced with the presence of mPBAT coupling agent. This confirmed the effective compatibilization between the HP and PBAT.

The melting enthalpy and cooling enthalpy of the PBAT reduces with the increase in the loading of the hemp powder, which indicated that the crystal formation and melt crystallization of the PBAT is hindered by the presence of hemp powder. In addition, the reduction of the PBAT contents with the addition of hemp powder and MA could also be the reasons for the reduced energy required to melt the crystals and reduces the Tₘ of the biocomposites. The calculated degree of crystallinity, X_{c} is decreased upon the addition of HP in PBAT. At 40 wt % of HP, the X_{c} of the PBAT reduced from 3.77% to 2.70% (see Table 3)

TABLE 3
Thermal properties of PBAT and its biocomposites at different contents of hemp
powder with and without MA coupling agents.

| | Glass transition | Melting | Enthalpy of | | Enthalpy of | |
|---|---|---|---|---|---|---|
| | temperature, | temperature, | fusion, ΔHₘ, | Crystallization | fusion, ΔH_{c}, | Degree of |
| | T_{g}, | Tₘ, | (Heating) | temperature, T_{c}, | (Cooling) | Crystallinity, |
| Samples | (° C.) | (° C.) | (J/g) | (° C.) | (J/g) | X_{c,} (%) |
| PBAT | −34.47 | 121.90 | 4.30 | 87.55 | 8.90 | 3.77 |
| PBAT-10HP | −34.77 | 124.95 | 3.35 | 86.98 | 7.90 | 3.27 |
| PBAT-20HP | −34.83 | 122.53 | 3.11 | 88.73 | 7.02 | 3.41 |
| PBAT-30HP | −35.04 | 123.14 | 2.61 | 89.66 | 5.77 | 3.27 |
| PBAT-40HP | −33.89 | 123.01 | 1.85 | 90.95 | 4.75 | 2.70 |
| PBAT-10HP-M | −33.25 | 123.21 | 2.93 | 86.48 | 8.01 | 2.86 |
| PBAT-20HP-M | −33.34 | 119.87 | 2.75 | 86.43 | 6.79 | 3.02 |
| PBAT-30HP-M | −33.18 | 120.73 | 2.51 | 86.50 | 5.99 | 3.15 |
| PBAT-40HP-M | −32.57 | 121.14 | 1.81 | 88.67 | 4.04 | 2.65 |

As depicted in FIG. 3B, the T. of the PBAT was not significantly affected with the addition of HP up to 30 wt % (only ˜1° C. differences). The T_{c} shifted to a higher temperature when the HP content reached 40 wt %. The intensity of the T_{c} has reduced and broadened as the hemp powder loading increased. This corresponds to the variations in PBAT's crystallite size when HP was incorporated. The crystallization process of the 40 wt % HP-filled PBAT occurred at ˜91° C. as compared to 87° C. for the neat PBAT. This indicates that the presence of HP could induce the growth of heterogeneous nucleation and crystallization of the PBAT.

Overall, the X_{c} of the HP/PBAT with the addition of MA coupling agent displayed reduction as compared to those without mPBAT. The coupling effect and effective interfacial adhesion between the matrix and hemp powder with the addition of the mPBAT coupling agent caused a higher degree of interruption to the crystallization process and hence the overall degree of crystallinity [24]. Therefore, the nucleation rate and X_{c} of the PBAT were reduced with the addition of mPBAT as the interphases of the composites improved.

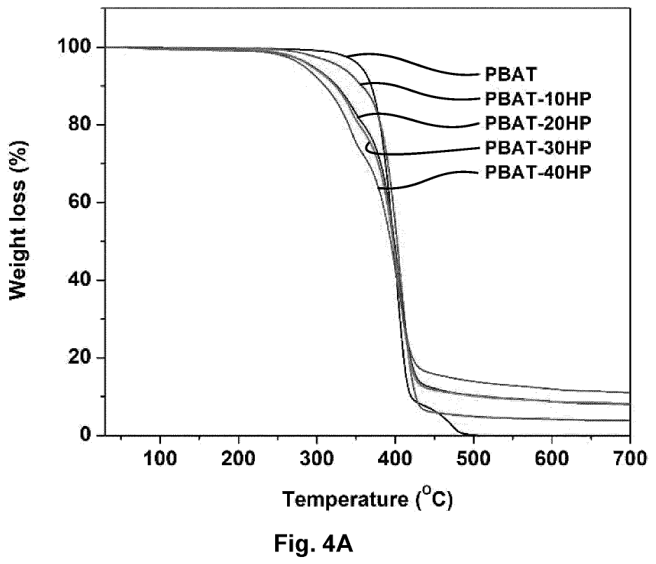

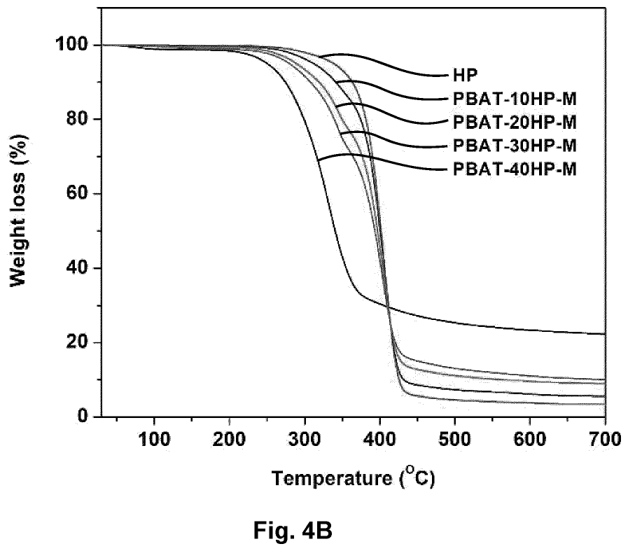

FIGS. 4A and 4B depict the results of TGA study of the biocompsites. The degradation onset (Tₒₙ) for HP was found to be 281° C. which was far lower than Tₒₙ of PBAT (˜372° C.). In the case of the biocomposites, HP's degradation temperature has shifted to higher temperatures due to encapsulation of the HP with the PBAT chains which reduces the generation and escape of HP degradation products, such as gases. This encapsulation appeared more prominent in the case of the biocomposites with mPBAT. At least 10° C. upshift in Tₒₙ was observed with the incorporation of mPBAT as opposed to the neat PBAT as a matrix of the biocomposites. In the case of the biocomposites with mPBAT, the lowest Tₒₙ witnessed was 331° C., which was high for biocomposites. The observed char formation at the end of the degradation of the biocomposites was also consistent with the loading levels of the HP.

### Mechanical and Thermo-Mechanical Characteristic of Biocomposite

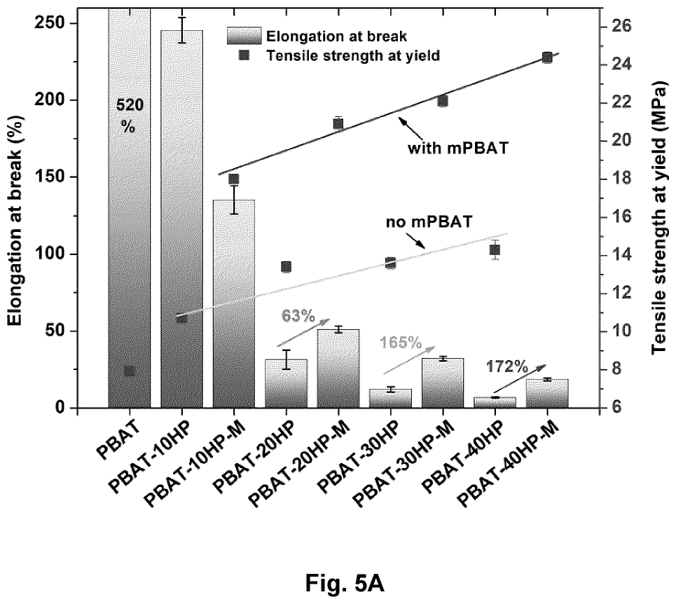

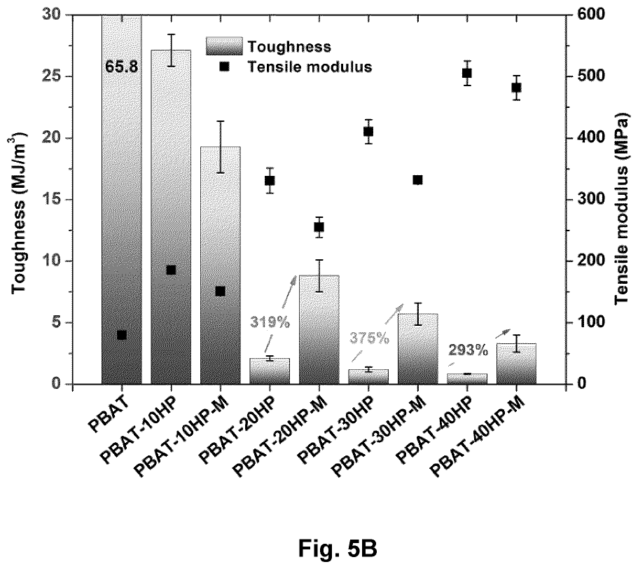

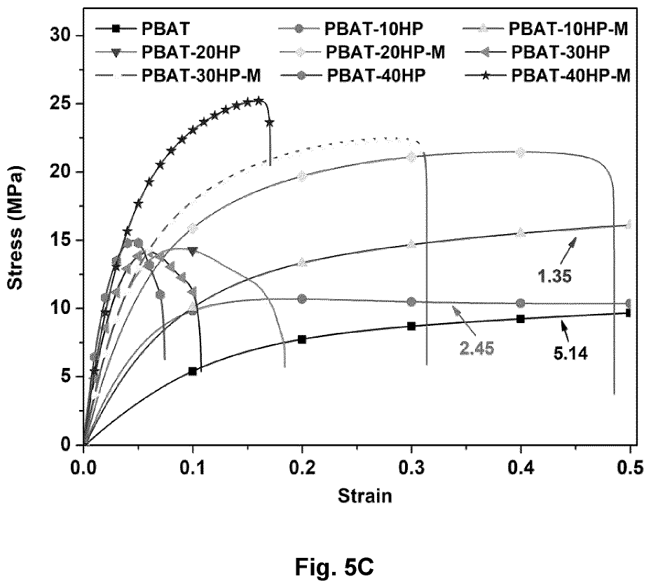

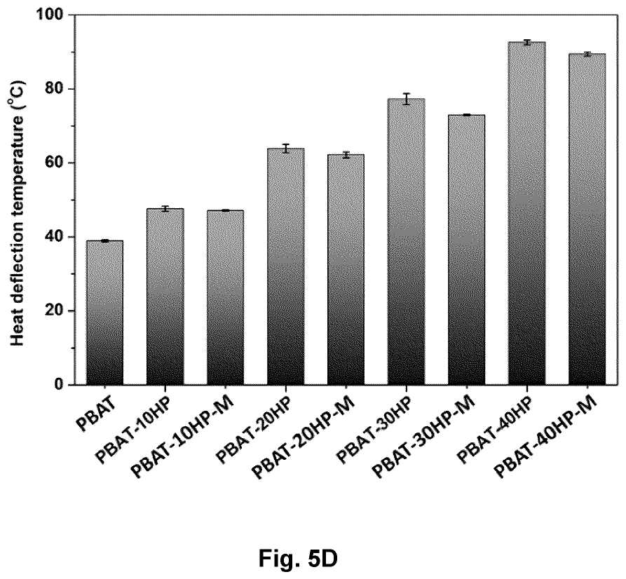

FIGS. 5A-5D depict the results of tensile testing of the exemplary biocompsites. The tensile strength at yield (TS) and tensile modulus (TM) increased gradually from 7.9 MPa and 79.5 MPa for the unfilled PBAT to 14.3 MPa and 505 MPa, respectively after the addition of 40% HP. An increase in TS and TM showed the reinforcing effect of the HP. On the contrary, the elongation at break has reduced drastically to 6.8% (PBAT-40HP) from 520% (PBAT) showing the relatively weak interaction between HP and PBAT chains. The TS was improved to 24.4 MPa upon the use of 10% mPBAT showing a remarkable (209%) improvement accompanied by the expected reduction in TM. The ultimate tensile strength (UTS), it increased from 18.7 MPa to 24.4 MPa (31% improvement) (Table 3). This significant uplift in TS showed the improvement in the interfacial adhesion between the HP and PBAT chains due to the coupling effect of the mPBAT. In comparison to the highly filled PBAT, improvement in the elongation at break was observed with the incorporation of mPBAT. For example, in the case of PBAT with 30% HP, a 165% (FIG. 5A) improvement was observed after the addition of 10% mPBAT which resulted in a 375% improvement in its toughness (FIG. 5B).

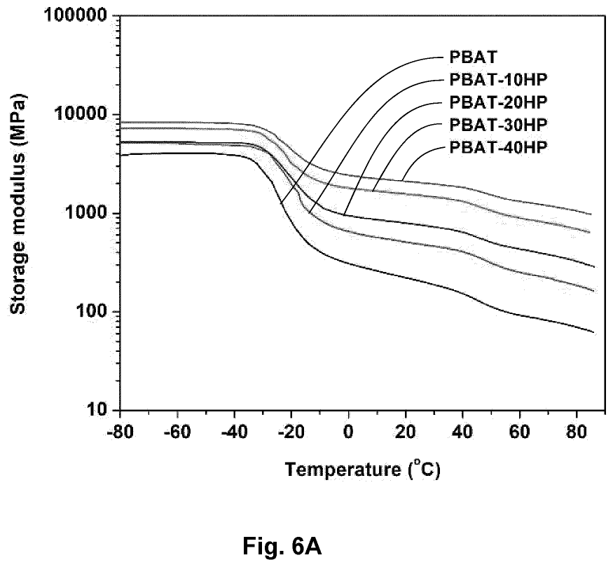

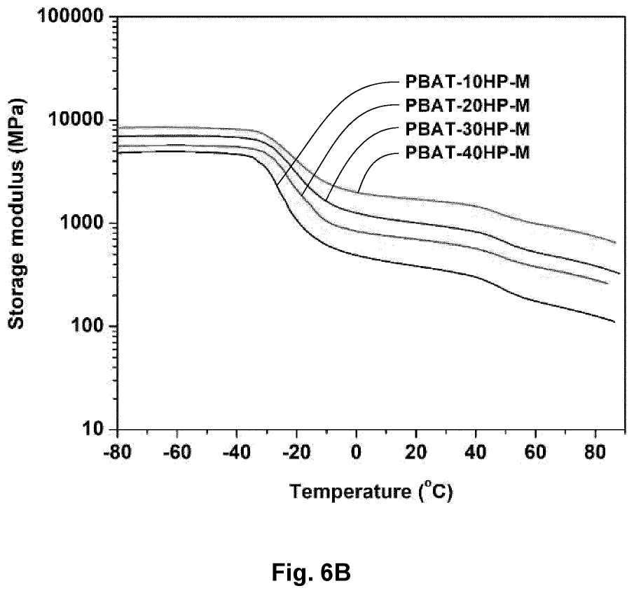

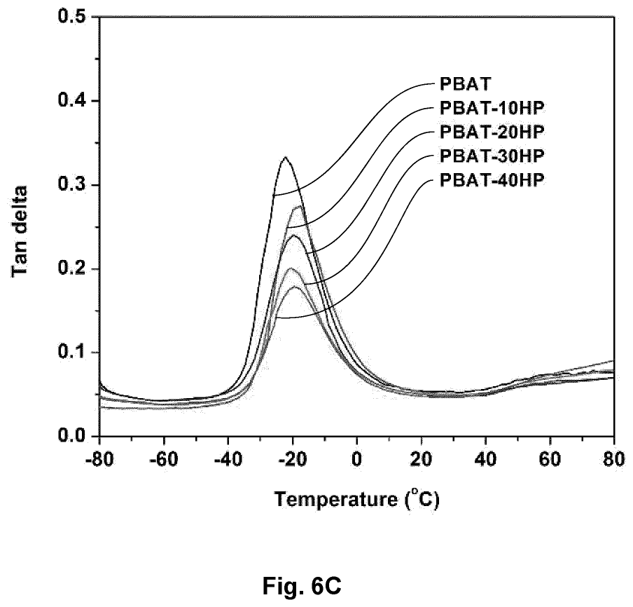

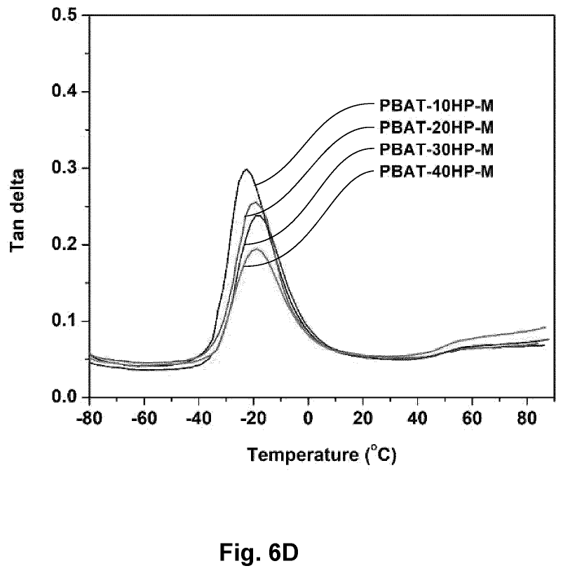

FIGS. 6A-6D depict effect of temperature on specimen load bearing capability was evaluated using DMA analysis against temperature. A significant increase in the storage modulus over the studied temperature range was noted with the incorporation of the HP filler. At 25° C., unfilled PBAT displayed a storage modulus of 205 MPa, whereas biocomposites with 40 HP (PBAT-40HP) presented 2034 MPa. On the contrary, the incorporation of mPBAT (PBAT-40HP-M) reduced the storage modulus to 1652 MPa, which may be associated with the plasticizing effect of mPBAT which contains small molecular weight chains (FIG. 6A and FIG. 6B). At lower temperatures, similar phenomena were observed. Tan delta which is the indicator of glass transition in the polymeric biocomposites, was found to be between −18° C. to −22° C. (FIG. 6C and FIG. 6D), which is quite dissimilar to DSC data. This variation in glass transition in DSC and DMA is as a result of the different mechanisms used for the analysis.

For real-life applications, the heat deflection temperature (HDT) is a very important parameter that need to be considered. The data for HDT for the biocomposites are shown in FIG. 5D. The restriction of PBAT chains due to the incorporation of HP led to a noteworthy improvement in HDT. In the case of pristine PBAT, HDT was found to be around 39° C. which increased to 93° C. upon the addition of 40% HP. The addition of mPBAT slightly reduced the HDT to 90° C. resulting from the plasticization effect of low molecular weight PBAT chains.

### Rheological Properties of the PBAT Biocomposites

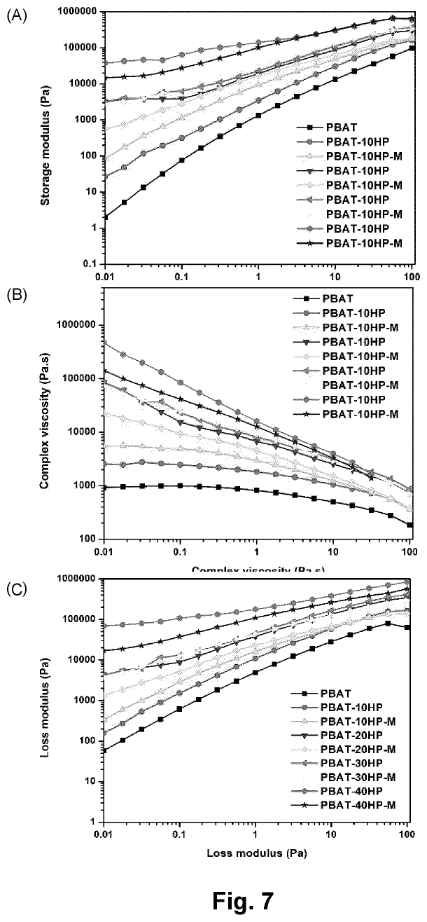

FIGS. 7A-7C depicts the melt rheological properties of the developed PBAT biocomposites, i.e. complex viscosity, storage modulus and loss modulus as a function of frequency sweep. It was found that the complex viscosity of the PBAT exhibited Newtonian behavior at low-frequency sweep. While shear thinning behavior gradually took over at high frequency (FIG. 7A). Similarly, for the storage modulus and loss modulus, the PBAT showed no frequency dependence at the low to mid-frequency range, which reflects a Newtonian behavior. The reinforcing effect of the HP in the PBAT can be clearly seen in the rheological behavior, as the complex viscosity, storage modulus, and loss modulus of the PBAT are lower than the PBAT-HP biocomposites. The complex viscosity, storage modulus and loss modulus of the PBAT increased with the increase in the loading levels of the HP (FIG. 7A-C). The complex viscosity of the PBAT at low frequency has gradually changed to shear thinning behavior as the HP contents increased above 20 wt %. The increase in complex viscosity is also applicable for the enhancement in the storage and loss modulus.

The storage and loss modulus of the neat PBAT showed a typical liquid-like melt deformation response. As the HP increased in the PBAT-HP biocomposites, the storage modulus and loss modulus has also shifted towards a plateau at low frequency (FIG. 7B-C).

The PBAT-10HP with mPBAT showed an enhancement in the complex viscosity, storage and loss modulus as compared to the PBAT-10HP. This indicated greater compatibility and interfacial interactions between components and led to a higher complex viscosity. Besides enhancing the hemp powder-PBAT interactions, it was noted that MA could also cause mild crosslinking of the PBAT chains. The hydroxyl and carbonyl groups of the PBAT can be readily connected with the aid of MA during reactive extrusion. As a result, the complex viscosity, storage, and loss modulus of the PBAT were improved when processed with mPBAT. However, the complex viscosity of the PBAT-HP was found to be higher than the PBAT-HP-M at above 20 wt % of HP contents. A similar trend was observed for both storage and loss modulus, indicating that the mPBAT compatibilization effect improved the chain mobility of PBAT and the dispersibility of hemp powder at high HP content. The coupling effect induces flexibility and hence reduces the complex viscosity. The reduction in complex viscosity of the PBAT biocomposites with the aid of mPBAT are encouraging due to the ease of processing at high hemp powder content.

### Mechanism Involved in Improved Interfacial Adhesion of HP and PBAT

The incorporation of mPBAT in the biocomposite using a reactive extrusion process resulted in a chemical reaction between mPBAT and hemp powder and form a covalent bond. The formation of a chemical bond encapsulates the HP particles with PBAT chains which can easily be dispersed and interact with PBAT chains upon melt reactive extrusion processing. This improved interfacial interaction significantly affected the tensile strength of the developed biocomposite along with elongation at break and toughness at higher loading (20-40%) of hemp powder.

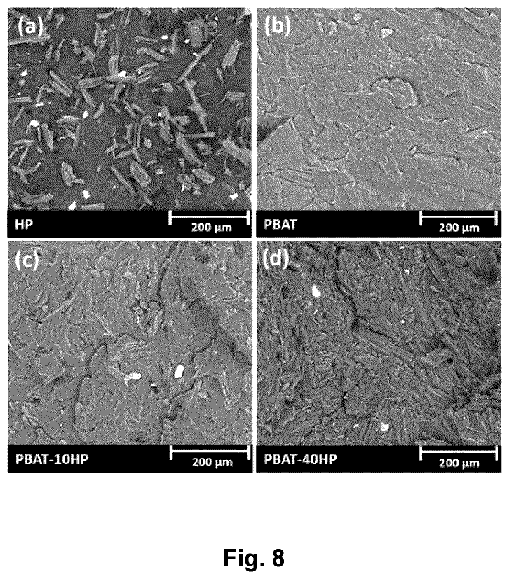

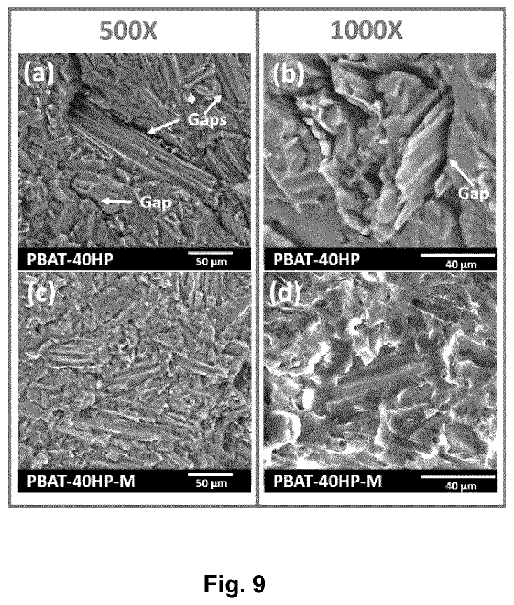

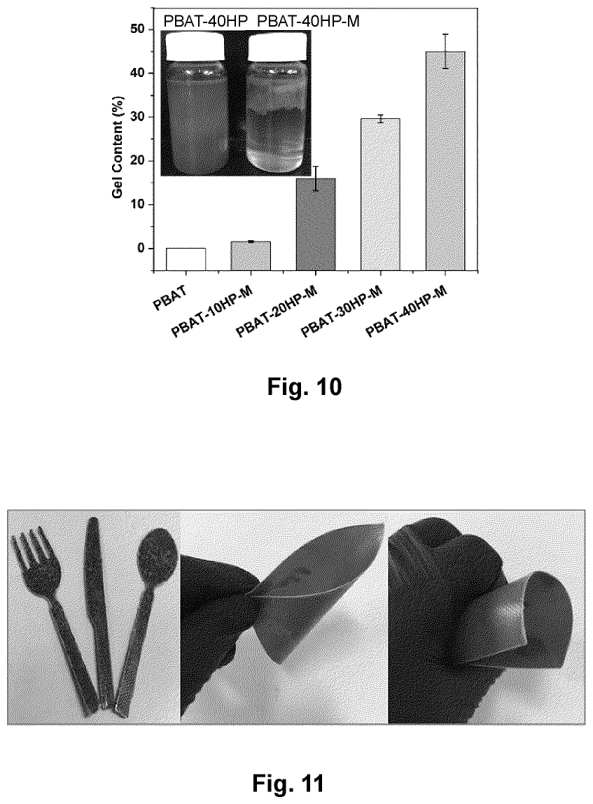

The resulting improvement in interfacial adhesion between HP and PBAT is observed using SEM and presented in FIGS. 8A-8D and FIGS. 9A-9D. It can be seen that the hemp powder exhibited corrugated surface structures with the variation of particle size. The fractured surfaces of neat PBAT, PBAT-10HP and PBAT-40HP biocomposites are presented in FIG. 8B-D, respectively. The PBAT-40HP exhibited poor particles dispersion with overlapping particles as a result of the high loading, while the PBAT-10HP displayed good particle distribution without substantial aggregations. Comparisons of the SEM fractured surfaces of PBAT-HP with and without mPBAT are displayed in FIG. 9A-D with two different magnifications. It can be noted that the PBAT-HP biocomposites exhibited poor particles-matrix interactions with large interfacial gaps (FIG. 9A-B). This indicates the surface incompatibility and low interfacial adhesion between the hemp powder and PBAT due to wide disparity in surface polarity. The particles-matrix interface of the biocomposites was found to be significantly enhanced with the incorporation of mPBAT compatibilizer. The hemp powder is completely encapsulated and adhering to the PBAT (FIG. 9C-D). There are no noticeable gaps present on the particle-matrix interface as can be seen when mPBAT was added in the PBAT-HP. The enhanced interfacial interaction with the addition of mPBAT in the PBAT-HP was also reflected in the tensile strength and elongation at break data discussed in previous sections. The reaction of MA with PBAT and its further reaction with HP leads to gel formation in the polymeric system suggesting successful bridge formation (FIG. 10).

As discussed above, the incorporation of hemp powder enhances the tensile strength and tensile modulus of PBAT at higher loading. However, higher loading level reduces the toughness and elongation at break of the resulting biocomposites. Reactive extrusion of PBAT with hemp powder and its compatibilization elevate the tensile strength along with the toughness and elongation at break.

Representative cutlery and flexible films are prepared using PBAT-40HP-M samples as shown in FIG. 11 to showcase the processability, and application of the fabricated biocomposites. Additionally, higher loading of HP may also contribute to the increased rate of biodegradation.

### Example 4: Fabrication of a Biocomposite Comprising PBAT, Starch, Plasticizer and Hemp Residue

A mixture comprising: a) about 60% by weight polybutylene adipate terephthalate (PBAT); b) about 27% by weight starch; c) about 12% by weight glycerol; c) about 0.5% by weight stearic acid; and d) about 0.5% by weight hemp powder, was extruded using a twin screw extruder OMEGA 20 from STEER World, using the following temperature profile: 25-130-150-155-165-170-175° C., at a feeding rate of about 15 lb/h and a screw speed of 410 RPM.

### Mechanical and Thermo-Mechanical Analysis

Tensile properties of a sample of the product of Example 4 were measured employing a Universal Tensile Machine AGS-X series from Shimadzu with a 500 N load cell at crosshead speed of 5 mm/min and a gauge length of 25 mm.

Specimens were injection molded in dumbbell shape as per ASTM D638 type V. Results with the average are summarized in Table 4 below:

TABLE 4

| | Tensile modulus | Tensile strength | Elongation at break |
|---|---|---|---|
| Sample | (MPa) | (MPa) | (%) |
| Example 4 | 34.5 ± 1.2 | 4.4 ± 0.6 | 184 ± 48* |

*average of 3 replicates

The biocomposite prepared in Example 4 can be used for injection molding to form hard containers and figures.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

### CITED REFERENCES

1. Geyer, R., J. R. Jambeck, and K. L. Law, Production, use, and fate of all plastics ever made. Science Advances, 2017. 3 (7): p. e1700782.
2. Millet, H., et al., The Nature of Plastics and Their Societal Usage, in Plastics and the Environment. 2019, The Royal Society of Chemistry. p. 1-20.
3. The future of plastic. Nature Communications, 2018. 9 (1): p. 2157.
4. Jambeck, J. R., et al., Plastic waste inputs from land into the ocean. Science, 2015. 347 (6223): p. 768-771.
5. Di Bartolo, A., G. Infurna, and N. T. Dintcheva, A Review of Bioplastics and Their Adoption in the Circular Economy. Polymers, 2021. 13 (8): p. 1229.
6. Mekonnen, T., et al., Progress in bio-based plastics and plasticizing modifications. Journal of Materials Chemistry A, 2013. 1 (43): p. 13379-13398.
7. Nakayama, D., et al., Biodegradable Composites Developed from PBAT/PLA Binary Blends and Silk Powder: Compatibilization and Performance Evaluation. ACS Omega, 2018. 3 (10): p. 12412-12421.
8. Mohanty, A. K., et al., Composites from renewable and sustainable resources: Challenges and innovations. Science, 2018. 362 (6414): p. 536-542.
9. Xing, Q., et al., Biodegradable and High-Performance Poly (butylene adipate-co-terephthalate)—Lignin UV-Blocking Films. ACS Sustainable Chemistry & Engineering, 2017. 5 (11): p. 10342-10351.
10. Meng, D., et al., Biodegradable Poly (butylene adipate-co-terephthalate) composites reinforced with bio-based nanochitin: Preparation, enhanced mechanical and thermal properties. Journal of Applied Polymer Science, 2020. 137 (12): p. 48485.
11. Muthuraj, R., M. Misra, and A. K. Mohanty, Biodegradable biocomposites from poly (butylene adipate-co-terephthalate) and miscanthus: Preparation, compatibilization, and performance evaluation. Journal of Applied Polymer Science, 2017. 134 (43): p. 45448.
12. Pinheiro, I. F., A. R. Morales, and L. H. Mei, Polymeric biocomposites of poly (butylene adipate-co-terephthalate) reinforced with natural Munguba fibers. Cellulose, 2014. 21 (6): p. 4381-4391.
13. Moustafa, H., et al., Utilization of Torrefied Coffee Grounds as Reinforcing Agent To Produce High-Quality Biodegradable PBAT Composites for Food Packaging Applications. ACS Sustainable Chemistry & Engineering, 2017. 5 (2): p. 1906-1916.
14. Le Digabel, F. and L. Averous, Effects of lignin content on the properties of lignocellulose-based biocomposites. Carbohydrate Polymers, 2006. 66 (4): p. 537-545.
15. Torres, S., et al., Green Composites from Residual Microalgae Biomass and Poly (butylene adipate-co-terephthalate): Processing and Plasticization. ACS Sustainable Chemistry & Engineering, 2015. 3 (4): p. 614-624.
16. Muniyasamy, S., et al., Biodegradable green composites from bioethanol co-product and poly (butylene adipate-co-terephthalate). Industrial Crops and Products, 2013. 43: p. 812-819.
17. Xu, Z., X. Qiao, and K. Sun, Environmental-friendly corn stover/poly (butylene adipate-co-terephthalate) biocomposites. Materials Today Communications, 2020. 25: p. 101541.
18. de Oliveira, T. A., et al., Biodegradation of mulch films from poly (butylene adipate co-terephthalate), carnauba wax, and sugarcane residue. Journal of Applied Polymer Science, 2019. 136 (47): p. 48240.
19. Liu, W., et al., Properties of poly (butylene adipate-co-terephthalate) and sunflower head residue biocomposites. Journal of Applied Polymer Science, 2017. 134 (13).
20. Zhu, M., et al., Highly Anisotropic, Highly Transparent Wood Composites. Advanced Materials, 2016. 28 (26): p. 5181-5187.
21 Gupta, A., et al., Effects of Amphiphilic Chitosan on Stereocomplexation and Properties of Poly (lactic acid) Nano-biocomposite. Scientific Reports, 2018. 8 (1): p. 4351.
22 Arabeche, K., et al., Physical and rheological properties of biodegradable poly (butylene succinate)/Alfa fiber composites. Journal of Thermoplastic Composite Materials. 0 (0): p. 0892705720904098.
23 Chang, C. C., B. M. Trinh, and T. H. Mekonnen, Robust multiphase and multilayer starch/polymer (TPS/PBAT) film with simultaneous oxygen/moisture barrier properties. Journal of Colloid and Interface Science, 2021. 593: p. 290-303.
24. Sewda, K. and S. N. Maiti, Crystallization and melting behavior of HDPE in HDPE/teak wood flour composites and their correlation with mechanical properties. Journal of Applied Polymer

1. A composition for use in making a biodegradable biocomposite, the composition comprising:
a) about 30 to about 99.5% by weight of a polybutylene adipate terephthalate (PBAT)-component;
b) about 0.5 to about 50% by weight hemp residue comprising ground hemp stalk wherein the hemp hurd and/or fibers are ground and/or sliced into micron size particles; and
c) optionally about 0.1 to about 50% by weight of:
PBAT grafted with one or more compatibilizers selected from maleic anhydride, glycidyl methacrylate, pyromellitic anhydride, acrylic acid, polyacrylic acid, methylene diphenyl diisocyanate, poly(glycidyl methacrylate, copolymer(s) of glycidyl methacrylate and/or copolymers of acrylic acid, and/or
one or more compatibilizers selected from maleic anhydride, pyromellitic anhydride, acrylic acid; polyacrylic acid, and methylene diphenyl diisocyanate.

2. The composition of claim 1, wherein the PBAT component is polybutylene adipate terephthalate (PBAT), and the composition comprises about 0.1 to about 50% of the PBAT grafted with one or more said compatibilizers.

3. The composition of claim 2, further comprising about 20 to about 40% by weight of a plasticizer.

4. The composition of claim 1, wherein the PBAT-component is a mixture of PBAT, starch, and a plasticizer, wherein PBAT is about 50 to about 65% by weight of the composition, the starch is about 15 to about 35% by weight of the composition, and the plasticizer is about 10 to about 15% by weight of the composition.

5. The composition of claim 1, wherein the PBAT-component is a PBAT-thermoplastic starch blend, wherein PBAT is about 50 to about 65% by weight of the composition, and the thermoplastic starch is about 30 to about 40% by weight of the composition.

6. The composition of claim 1, wherein the hemp residue comprises particles having length about 75 to about 150 μm, width about 15 to about 40 μm, and an aspect ratio of about 3.5 to about 5.

7. The composition of claim 1, wherein the hemp residue has density about 1.0 to about 2.0 g/cm³.

8. (canceled)

9. The composition of claim 1, wherein the hemp residue is treated to remove THC & CBD therefrom.

10. The composition of claim 1, further comprising about 1 to about 3% by weight of a processing agent.

11. The composition of any claim 1, further comprising an inorganic filler.

12. A biocomposite made from the composition as defined in claim 1.

13. A biocomposite comprising a mixture of:
a) about 30 to about 99.5% by weight polybutylene adipate terephthalate (PBAT)-component;
b) about 0.5 to about 50% by weight hemp residue comprising ground hemp stalk wherein the hemp hurd and/or fibers are ground and/or sliced into micron size particles; and
c) optionally about 0.1 to about 50% by weight of:
PBAT grafted with one or more compatibilizers selected from maleic anhydride, glycidyl methacrylate, pyromellitic anhydride, acrylic acid, polyacrylic acid, methylene diphenyl diisocyanate; poly(glycidyl methacrylate, copolymer(s) of glycidyl methacrylate and/or copolymers of acrylic acid, and/or
one or more compatibilizers selected from maleic anhydride, pyromellitic anhydride, acrylic acid; polyacrylic acid, and methylene diphenyl diisocyanate,
wherein the mixture has been heated.

14. The biocomposite of claim 13, wherein the PBAT component is polybutylene adipate terephthalate (PBAT), and the biocomposite comprises about 0.1 to about 50% of the PBAT grafted with one or more said compatibilizers.

15. The biocomposite of claim 14, further comprising about 20 to about 40% by weight of a plasticizer.

16. The biocomposite of claim 13, wherein the PBAT-component is a mixture of PBAT, starch, and a plasticizer, wherein PBAT is about 50 to about 65% by weight of the composition, the starch is about 15 to about 35% by weight of the composition, and the plasticizer is about 10 to about 15% by weight of the composition.

17. The biocomposite of claim 13, wherein the PBAT-component is a PBAT-thermoplastic starch blend, wherein PBAT is about 50 to about 65% by weight of the composition, and the thermoplastic starch is about 30 to about 40% by weight of the composition.

18. The biocomposite of claim 13, wherein the hemp residue comprises particles having length about 75 to about 150 μm, width about 15 to about 40 μm, and an aspect ratio of about 3.5 to about 5.

19. The biocomposite of claim 13, wherein the hemp residue has density about 0.2 to about 2.0 g/cm³.

20. (canceled)

21. The biocomposite of claim 13, wherein the hemp residue has been pre-treated to remove THC and CBD.

22. The biocomposite of any claim 13, further comprising about 1 to about 3% by weight of a processing agent.

23. The biocomposite of claim 13, further comprising an inorganic filler.

24. A method of preparing a biocomposite as defined in claim 1, the method comprising:
a) admixing the PBAT-component with hemp residue, and optionally with the compatibilizer, and
b) extruding said admixture at an extrusion temperature sufficient to melt at least the PBAT.

25. The method of claim 24, wherein the admixture is extruded via a screw extruder with a screw speed of about 80 to about 120 rpm, at a processing temperature of about 150°-about 220° C.

26. The method of claim 24, wherein the admixture is extruded via a screw extruder with a screw speed of about 380 to about 450 rpm, at a processing temperature of about 130°-about 200° C.

27. (canceled)

28. A method of preparing a biocomposite as defined in claim 13, wherein the composite comprises PBAT grafted with one or more compatibilizers, and the method comprises:
a) preparing the grafted PBAT by combining PBAT, the one or more compatibilizers, and a free radical initiator to form a reaction mixture, and melt processing the reaction mixture to form a compatibilizer-grafted PBAT; and
b) mixing the compatibilizer-grafted PBAT prepared in step a) with the PBAT-component, hemp residue, and optional plasticizer(s) and/or filler(s), and extruding said mixture at an extrusion temperature sufficient to melt at least the PBAT.
